(19) United States
(12) Patent Application Publication
(10) Pub. No.: US 2006/0262407 A1
(43) Pub. Date: Nov. 23, 2006

(54) Light-splitting device

(75) Inventors: Kuang-Wei Chang, Xiao-Bian (CN); Shou-Chy Jia, Tan-Tzu Hsiang (TW)

Correspondence Address: BANNER & WITCOFF, 1001 G STREET N W, SUITE 1100, WASHINGTON, DC, 20001, US

(73) Assignee: Asia Optical Co., Inc., T.E.P.Z. (TW)

(21) Appl. No.: 11/429,939

(22) Filed: May 9, 2006

(30) Foreign Application Priority Data
May 10, 2005 (TW) 094115029

(51) Int. Cl. G02B 27/10

(52) U.S. Cl. 359/618

(57) ABSTRACT

A light-splitting device is adapted to receive source light provided by a light source, and includes a plurality of light-guiding surface segments capable of splitting the source light provided by the light source into a plurality of light beam components that travel in a first direction. The light-guiding surface segments are spaced apart from each other in a second direction.

### CROSS-REFERENCE TO RELATED APPLICATION

This application claims priority of Taiwanese Application No. 094115029, filed on May 10, 2005.

### BACKGROUND OF THE INVENTION

1. Field of the Invention

The invention relates to an optical device, more particularly to a light-splitting device that is capable of splitting light into a plurality of light beam components and directing the light beam components in a particular direction.

2. Description of the Related Art

As shown in FIG. 1, a conventional optical projecting system includes a light source 1, a light tunnel 2, a transmissive color wheel 3, a digital micro-mirror device (DMD) 4, and a screen 5. The light source 1 is capable of providing source light 101. The light tunnel 2 is capable of receiving, guiding, and focusing the source light 101 to result in focused light. The transmissive color wheel 3 is rotatable about a rotation axis (X1), and includes a plurality of spiral light-filtering components 301 that are distributed around the rotation axis (X1). The light-filtering components 301 of the transmissive color wheel 3 include sequentially arranged red, blue and green light-filtering components (r), (b), (g), as best illustrated in FIG. 2. The red, blue and green light-filtering components (r), (b), (g) allow transmission of red, blue and green light therethrough, respectively. The transmissive color wheel 3 rotates at an extremely high speed about the rotation axis (X1) as the focused light exits the light tunnel 2 so as to filter the focused light into red, blue and green focused light components sequentially and cyclically. The red, blue and green focused light components are subsequently projected toward the DMD 4, which then modulates the red, blue and green focused light components into red, blue and green modulated light components, respectively, and projects them onto the screen 5 so that colored images are presented on the screen 5.

Although the conventional optical projecting system is capable of projecting colored images, the following shortcomings exist during use:

1. The focused light components that are reflected back to the light tunnel 2 by the transmissive color wheel 3 causes the light tunnel 2 to overheat such that the service life of the light tunnel 2 is shortened and the quality of the conventional optical projecting system is thus adversely affected.

2. As shown in FIG. 1, the light source 1, the light tunnel 2, the transmissive color wheel 3, and the DMD 4 are aligned in a direction parallel to the rotation axis (X1). In addition, the light tunnel 2 extends parallel to the rotation axis (X1) and has a definite length. For these reasons, the conventional optical projecting system is bulky and occupies too much space.

### SUMMARY OF THE INVENTION

Therefore, the object of the present invention is to provide a light-splitting device that is capable of splitting light into a plurality of light beam components, and that is capable of reducing the size of an optical projecting system which incorporates the light-splitting device.

According to one aspect of the present invention, there is provided a light-splitting device adapted to receive source light provided by a light source. The light-splitting device includes a plurality of light-guiding surface segments capable of splitting the source light provided by the light source into a plurality of light beam components that travel in a first direction. The light-guiding surface segments are spaced apart from each other in a second direction. According to another aspect of the present invention, there is provided a light-splitting device adapted to receive source light provided by a light source, and capable of splitting the source light provided by the light source into a plurality of light beam components that travel in a first direction. The light-splitting device includes: a light-incident side for receiving the source light provided by the light source; and a light-exit side including a plurality of light-transmissive light-exit parts that respectively permit transmission of the source light therethrough to result in the light beam components that travel in the first direction.

According to yet another aspect of the present invention, there is provided a light-splitting device adapted to receive source light provided by a light source. The light-splitting device includes: a plurality of parallel and non-coplanar light-guiding surface segments spaced apart from each other and capable of splitting the source light provided by the light source into a plurality of light beam components; and a plurality of parallel and non-coplanar connecting surface segments. Each of the connecting surface segments interconnects an adjacent pair of the light-guiding surface segments so as to configure the light-splitting device with a staircase surface.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional optical projecting system;

FIG. 2 is a fragmentary schematic view of a transmissive color wheel used in the conventional optical projecting system;

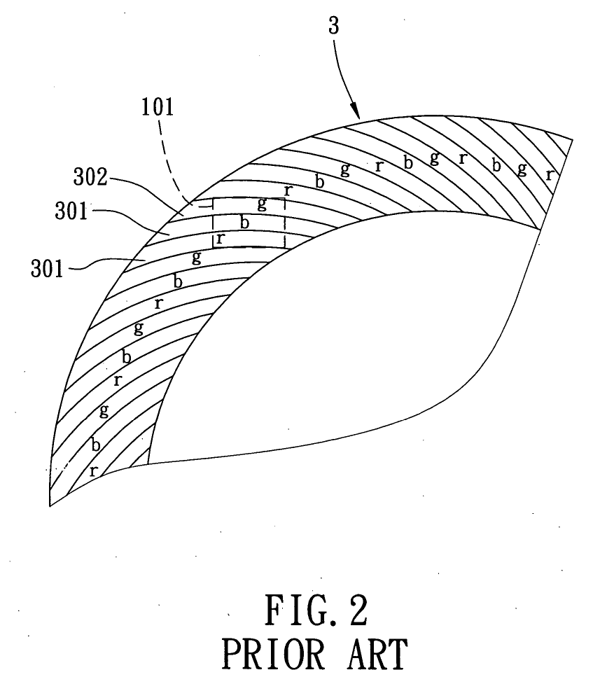

FIG. 3 is a perspective view of the first preferred embodiment of a light-splitting device according to the present invention;

FIG. 4 is a schematic view of an optical projecting system incorporating the light-splitting device of the first preferred embodiment;

FIG. 5 is a perspective view of the second preferred embodiment of a light-splitting device according to the present invention; and

FIG. 6 is a schematic view of an optical projecting system incorporating the light-splitting device of the second preferred embodiment.

### DETAILED DESCRIPTION OF THE PREFERRED EMBODIMENTS

Before the present invention is described in greater detail, it should be noted herein that like elements are denoted by the same reference numerals throughout the disclosure.

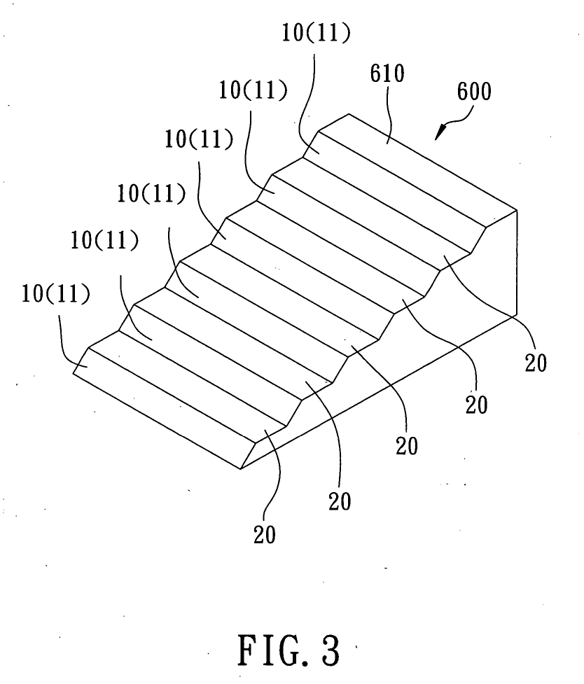

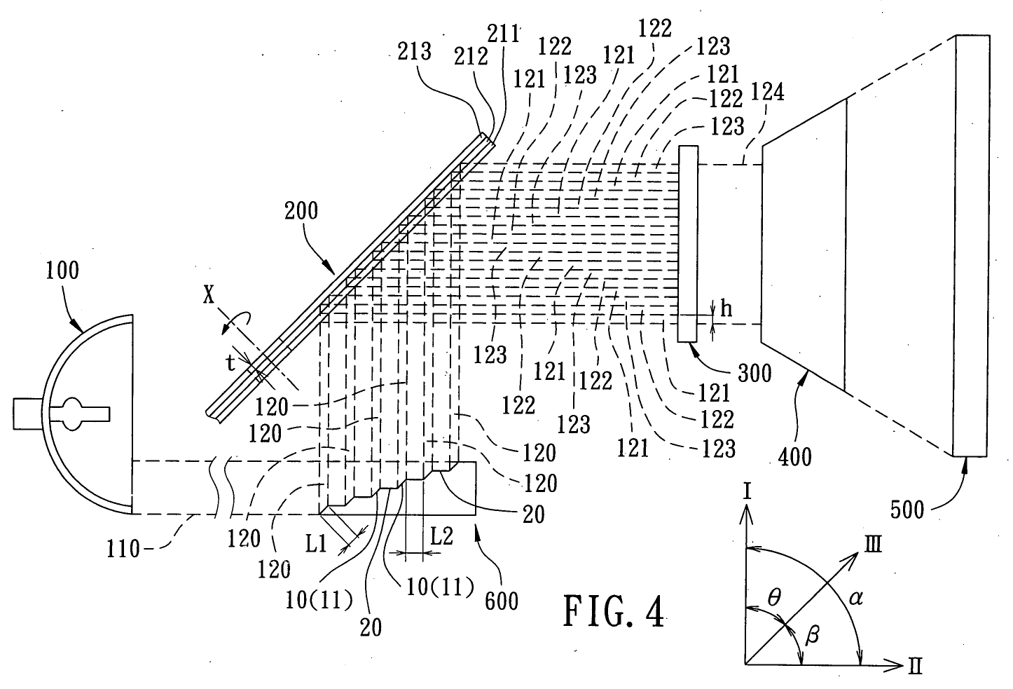

Shown in FIG. 3 is the first preferred embodiment of a light-splitting device 600 according to the present invention. Shown in FIG. 4 is an optical projecting system incorporating the light-splitting device 600 according to the first preferred embodiment. Aside from the light-splitting device 600, the optical projecting system includes a light source 100, a reflective color wheel 200, a light-modulating unit 300, a projecting lens 400, and a screen 500. The light source 100 is capable of providing composite source light 110. The reflective color wheel 200 includes first, second and third light-filtering plates 211, 212, 213 stacked along a rotation axis (X). The first, second and third light-filtering plates 211, 212, 213 altogether constitute first, second and third multi-layer light-reflecting sections, each capable of splitting light into red, blue and green colored light beam components 121, 122, 123. In this embodiment, the light-modulating unit 300 is a transmissive liquid crystal device. It should be noted herein that depending on a particular design of the optical projecting system, the light-modulating unit 300 can also be a reflective liquid crystal device or a digital micro-mirror device (DMD).

As shown in FIG. 3 and FIG. 4, the light-splitting device 600 according to the first preferred embodiment includes a plurality of parallel and non-coplanar light-guiding surface segments 10, and a plurality of parallel and non-coplanar connecting surface segments 20 so as to configure the light-splitting device 600 with a staircase surface 610.

The light-guiding surface segments 10 are capable of splitting the source light 110 provided by the light source 100 into a plurality of light beam components 120 that travel in a first direction (I), and are spaced apart from each other in a second direction (II). Each of the connecting surface segments 20 interconnects an adjacent pair of the light-guiding surface segments 10. The connecting surface segments 20 extend in the second direction (II).

In this embodiment, the light-guiding surface segments 10 are each provided with a reflective film 11 so as to reflect the composite source light 110 from the light source 100 in the first direction (I) toward the reflective color wheel 200 to result in the light beam components 120. Each of the light-guiding surface segments 10 extends in a third direction (III), and has a first length (L1) extending in the third direction (III). The third direction (III) defines a first angle θ with the first direction (I). The first and second directions (I), (II) define a second angle α therebetween that is equal to 180 degrees subtracted by twice the first angle θ. The second and third directions (II), (III) define a third angle β therebetween. In this embodiment, the first angle θ is equal to 45 degrees. Therefore, the second angle α is equal to 90 degrees (α=180°−2×45°=90°). Consequently, the third angle β is equal to the second angle α subtracted by the first angle θ, i.e., β=α−θ=90°−45°=45°. In this embodiment, the light-splitting device 600 includes six of the light-guiding surface segments 10.

Each of the connecting surface segments 20, which interconnects a corresponding adjacent pair of the light-guiding surface segments 10, has a second length (L2) extending in the second direction (II).

In this embodiment, the light source 10 provides the composite source light 110 in the second direction (II) to the light-splitting unit 600. The reflective films 11 of the light-guiding surface segments 10 reflect the composite source light 110 in the first direction (I) to result in the composite light beam components 120. In order to prevent the connecting surface segments 20 from creating interference light beams when the composite source light 110 is incident thereupon, the connecting surface segments 20 can be light-transmissive or can be provided with light-absorbing films, respectively.

As shown in FIG. 4, the reflective color wheel 200 is disposed to receive the composite light beam components 120 from the light-splitting device 600. As the reflective color wheel 200 rotates at a high speed about the rotation axis (X) transverse to a plane that is parallel to the third direction (III), the first, second and third multi-layer light-reflecting sections of the reflective color wheel 200 further splits each of the composite light beam components 120 into the red, blue and green colored light beam components 121, 122, 123 traveling in the second direction (II) toward the light-modulating unit 300. In this embodiment, each of the first, second and third light-filtering plates 211, 212, 213 has a thickness (t) along the rotation axis (X). The light-modulating unit 300 is operable to modulate the first, second and third colored light beam components 121, 122, 123 in a conventional manner. The projecting lens 400 is disposed between the light-modulating unit 300 and the screen 500 to receive modulated light beam components, which altogether form an image light 124, from the light-modulating unit 300. The projecting lens 400 focuses and projects the image light 124 onto the screen 500 to form colored images thereon.

The red, blue and green colored light beam components 121, 122, 123 are lined up sequentially and cyclically on the light-modulating unit 300. In order for each of the red, blue and green colored light beam components 121, 122, 123 to have a predefined height (h) on the light-modulating unit 300, the first length (L1) of each of the light-guiding surface segments 10 should be equal in magnitude to the predefined height (h) of each of the red, blue and green colored light beam components 121, 122, 123 divided by sine of the first angle θ, i.e., L1=h/sin θ, the second length (L2) of each of the connecting surface segments 20 should be equal in magnitude to twice the predefined height (h) of each of the red, blue and green colored light beam components 121, 122, 123 divided by tangent of the first angle θ, i.e., L2=2×h/tan θ, and the thickness (t) of each of the first, second and third light-filtering plates 211, 212, 213 should be equal in magnitude to the predefined height (h) of each of the red, blue and green colored light beam components 121, 122, 123 multiplied by cosine of the first angle θ, i.e., t=h×cos θ.

In sum, the light-splitting device 600 according to the first preferred embodiment of the present invention has the following advantages:

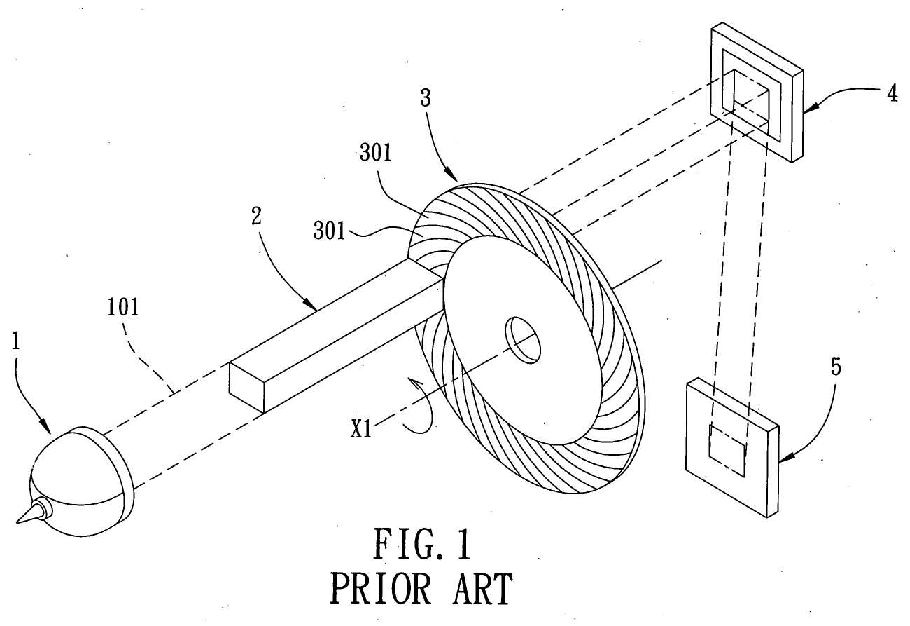

1. Since the light-splitting device 600 is capable of splitting the composite source light 110 into a plurality of the composite light beams 120, and is capable of directing these composite light beams 120 in the first direction (I), the light-splitting device 600 can replace the light tunnel 2 (shown in FIG. 1) in an optical projecting system without encountering the overheating problem of the light tunnel 2 in the prior art.

2. In an optical projecting system incorporating the light-splitting device 600, since the light-splitting device 600, and the light source 100 and the reflective color wheel 200 of the optical projecting system are not disposed on a straight line, the length of an optical projecting system incorporating the light-splitting device 600 is shorter than that of the prior art.

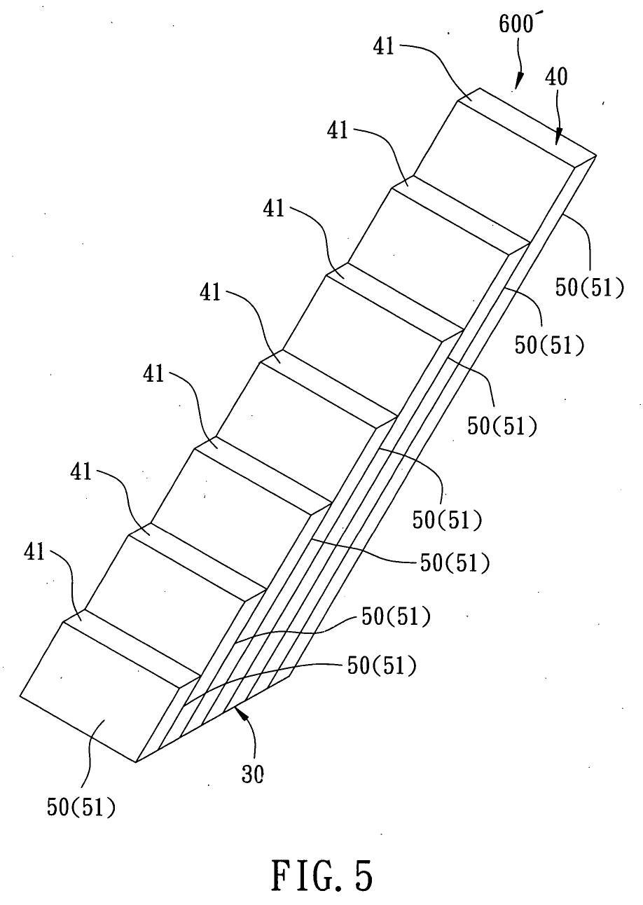

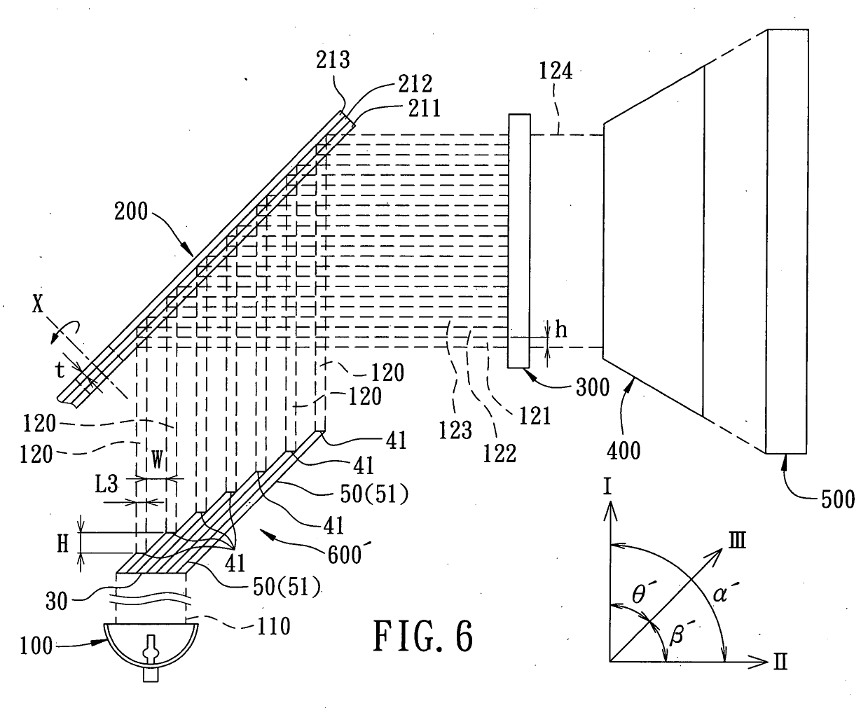

Shown in FIG. 5 is the second preferred embodiment of a light-splitting device 600′ according to the present invention. Shown in FIG. 6 is an optical projecting system incorporating the light-splitting device 600′ according to the second preferred embodiment. Except for the light-splitting device 600′, the components of the optical projecting system are the same as those disclosed in the previous embodiment.

As shown in FIG. 5 and FIG. 6, the light-splitting device 600′ according to the second preferred embodiment includes alight-incident side 30 for receiving the composite source light 110 from the light source 100, and a light-exit side 40 having a plurality of light-transmissive light-exit parts 41 that respectively permit transmission of the composite source light 110 therethrough to result in the composite light beam components 120 that travel in the first direction (I) toward the reflective color wheel 200. The light-exit parts 41 extend in the second direction (II) and are transverse to the first direction (I). In this embodiment, the light-exit side 40 includes seven of the light-exit parts 41. The light-splitting device 600′ further includes a plurality of connecting surface segments 50 that extend respectively from the light-incident side 30 to the light-exit parts 41 of the light-exit side 40 in the third direction (III) parallel to the plane that is transverse to the rotation axis (X) of the reflective color wheel 200. Each of the connecting surface segments 50 is provided with a reflective film 51, and spaces apart a corresponding adjacent pair of the light-exit parts 41 in the first direction (I) by a second height (H) and in the second direction (II) by a width (W).

In this embodiment, the light source 100 provides the composite source light 110 in the first direction (I) to the light-incident side 30 of the light-splitting device 600′. When the composite source light 110 enters the light-splitting device 600′ via the light-incident side 30, the composite source light 110 goes through multiple internal reflections within the light-splitting device 600′ due to the reflective films 51 of the connecting surface segments 50 and eventually exits the light-splitting device 600′ via the light-exit parts 41 of the light-exit side 40 to result in the composite light beam components 120.

The first and third directions (I), (III) define a first angle θ′ therebetween. The first and second directions (I), (II) define a second angle α′ therebetween. The second and third directions (II), (III) define a third angle β′ therebetween that is equal to the second angle α′ subtracted by the first angle θ′. In this embodiment, the first angle θ′ is equal to 45 degrees, and the second angle α′ is equal to 90 degrees. Therefore, the third angle β′ is equal to 45 degrees (β′=α′−θ′=90°−45°=45°).

As with the first preferred embodiment, each of the red, blue and green colored light beam components 121, 122, 123 has a predefined first height (h) on the light-modulating unit 300.

Each of the light-exit parts 41 has a length (L3) in the second direction (II) that is equal to the predefined first height (h) of each of the red, blue and green colored light beam components 121, 122, 123 multiplied by tangent of the first angle θ′, i.e., L3=h×tan θ′. The second height (H) between each adjacent pair of the light-exit parts 41 in the first direction (I) is equal to twice the predefined first height (h) of each of the red, blue and green colored light beam components 121, 122, 123, i.e., H=2×h. The width (W) between each adjacent pair of the light-exit parts 41 in the second direction (II) is equal to twice the predefined first height (h) of the red, blue and green colored light beam components 121, 122, 123 multiplied by tangent of the first angle θ′, i.e., W=2×h×tan θ′.

Each of the first, second and third light-filtering plates 211, 212, 213 of the reflective color wheel 200 has a thickness (t) along the rotation axis (X), and equal in magnitude to the predefined first height (h) of each of the red, blue and green colored light beam components 121, 122, 123 multiplied by sine of the first angle θ′, i.e., t=h×sin θ′.

As a result, the second preferred embodiment can attain the same advantages as the first preferred embodiment.

In conclusion, the light-splitting device 600, 600′ according to the present invention is not only capable of splitting light into a plurality of light beam components, but is also capable of effectively reducing the overall size of an optical projecting system which incorporates the same.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A light-splitting device adapted to receive source light provided by a light source, said light-splitting device comprising a plurality of light-guiding surface segments capable of splitting the source light provided by the light source into a plurality of light beam components that travel in a first direction, said light-guiding surface segments being spaced apart from each other in a second direction.

2. The light-splitting device as claimed in claim 1, wherein said light-guiding surface segments are capable of reflecting the source light in the first direction to result in the light beam components.

3. The light-splitting device as claimed in claim 2, wherein each of said light-guiding surface segments extends in a third direction defining a first angle with the first direction; and
wherein the first and second directions define a second angle therebetween that is equal to 180 degrees subtracted by twice the first angle.

4. The light-splitting device as claimed in claim 3, further comprising a plurality of connecting surface segments extending in the second direction, each of said connecting surface segments interconnecting an adjacent pair of said light-guiding surface segments.

5. The light-splitting device as claimed in claim 4, wherein said connecting surface segments are light-transmissive.

6. The light-splitting device as claimed in claim 4, wherein said connecting surface segments are capable of absorbing light.

7. The light-splitting device as claimed in claim 3, wherein the first angle is 45 degrees.

8. A light-splitting device adapted to receive source light provided by a light source, and capable of splitting the source light provided by the light source into a plurality of light beam components that travel in a first direction, said light-splitting device comprising:
a light-incident side for receiving the source light provided by the light source; and
a light-exit side including a plurality of light-transmissive light-exit parts that respectively permit transmission of the source light therethrough to result in the light beam components that travel in the first direction.

9. The light-splitting device as claimed in claim 8, wherein said light-exit parts extend in a second direction transverse to the first direction.

10. The light-splitting device as claimed in claim 9, further comprising a plurality of connecting surface segments that extend respectively from said light-incident side to said light-exit parts of said light-exit side in a third direction defining an angle with the first direction, each of said connecting surface segments being a reflective surface and spacing apart a corresponding adjacent pair of said light-exit parts in the first direction by a height and in the second direction by a width.

11. The light-splitting device as claimed in claim 10, wherein the angle is 45 degrees.

12. A light-splitting device adapted to receive source light provided by a light source, said light-splitting device comprising:
a plurality of parallel and non-coplanar light-guiding surface segments spaced apart from each other and capable of splitting the source light provided by the light source into a plurality of light beam components; and
a plurality of parallel and non-coplanar connecting surface segments, each of said connecting surface segments interconnecting an adjacent pair of said light-guiding surface segments so as to configure said light-splitting device with a staircase surface.

13. The light-splitting device as claimed in claim 12, wherein each of said light-guiding surface segments is capable of reflecting the source light provided by said light source to result in a corresponding one of the light beam components.

14. The light-splitting device as claimed in claim 12, wherein said connecting surface segments are light-transmissive.

15. The light-splitting device as claimed in claim 12, wherein said connecting surface segments are capable of absorbing light.
